(19) United States
(12) Patent Application Publication
(10) Pub. No.: US 2014/0300831 A1
(43) Pub. Date: Oct. 9, 2014

(54) TRANSPARENT CAPACITIVE TOUCH PANEL

(71) Applicant: Kai-Ti YANG, Taoyuan (TW)

(72) Inventor: Kai-Ti YANG, Taoyuan (TW)

(73) Assignee: Young Fast Optoelectronics Co., Ltd., Taoyuan (TW)

(21) Appl. No.: 13/858,106

(22) Filed: Apr. 8, 2013

(51) Int. Cl. G06F 1/16; G02B 1/10

(52) U.S. Cl. CPC G06F 1/169; G02B 1/10
USPC 349/12

(57) ABSTRACT

The capacitive touch panel includes a transparent substrate, a first transparent conductive layer, a first transparent insulative layer, a second transparent conductive layer, and a second transparent insulative layer. Each transparent conductive layer has a plurality of capacitive sensor rows. Every adjacent two of the capacitive sensor rows are formed with a gap to be insulated. The transparent insulative layers have a refractive index equal to or greater than that of the transparent conductive layers and fill the gaps. Each of the insulative layers is composed of a plurality of insulative coatings, and each coating is less than 100 nm in thickness.

### BACKGROUND OF THE INVENTION

1. Technical Field

The invention relates to touch panels for LCDs, particularly to transparent capacitive touch panels.

2. Related Art

In a typical capacitive touch panel, the two capacitive sensor rows along X-axis and Y-axis are arranged on two different conductive layers, and the two conductive layers are insulatedly superposed on a substrate. On each conductive layer, there are a plurality of capacitive sensor rows along the same axis, and all other material except the conductive sensor rows is removed to form gaps. Thus, every two adjacent capacitive sensor rows are insulated by the gaps.

To make a touch panel suitable for being installed before a display of an electronic device, usually the substrate is made of transparent glass and indium tin oxide (ITO) is used to be a conductive layer. As abovementioned, the pattern on the conductive layer includes an ITO material (i.e. capacitive sensor rows) and gaps. Because the ITO material and gaps possess different refractive indexes (RIs). In other words, the RIs of ITO and gap are about 1.8 and 1, respectively. This will cause uneven refraction of light passing through the conductive layer. As a result, the image shown on a display will be distorted, foggy or even glaring.

### SUMMARY OF THE INVENTION

An object of the invention is to provide a transparent capacitive touch panel, which possesses an even RI. This can improve optical properties of a touch panel.

Another object of the invention is to provide a transparent capacitive touch panel, which has a thicker insulative layer to increase insulation ability and to avoid deformation.

To accomplish the above objects, the capacitive touch panel of the invention includes a transparent substrate, a first transparent conductive layer, a first transparent insulative layer, a second transparent conductive layer, and a second transparent insulative layer. Each transparent conductive layer has a plurality of capacitive sensor rows. Every adjacent two of the capacitive sensor rows are formed with a gap to be insulated. The transparent insulative layers have a refractive index equal to or greater than that of the transparent conductive layers and fill the gaps.

The substrate may use a glass material with high transmittance such as soda lime glass, soda borosilicate glass, lead crystal glass, aluminosilicate glass or low-iron glass. Besides these materials, many other materials with high transmittance are available, such as polycarbonates (PC), polyethylene terephthalate (PET) or polymethylmethacrylate (PMMA).

The transparent conductive layers use a conductive material with high transmittance, such as indium tin oxide (ITO), indium zinc oxide (IZO), aluminum zinc oxide (AZO) or poly(3,4-ethylenedioxythiophene) (PEDOT).

The transparent insulative layers may use silicon dioxide (SiO₂), aluminum oxide (Al₂O₃) or niobium pentoxide (Nb₂O₅).

In a preferred embodiment, the insulative layer is composed of a plurality of insulative coatings. Such multiple coatings not only are easy to be processed, but also can increase thickness and insulation effect. The coatings may be made of two or more different materials. This can modify the overall refractive index of the insulative layer to match the conductive layer. Preferably, the coatings are three or an odd number more than three in number, and the odd layers are made of the same insulative material. This can balance the internal stress between coatings and avoid deformation. Additionally, each of the insulative layers is composed of a plurality of insulative coatings, and each coating is less than 100 nm in thickness. This can reduce internal stress to avoid deformation.

In an embodiment, the insulative layer is a transparent insulative bond, for example a polymeric optically clear adhesive (OCA) containing silicon dioxide (SiO₂), aluminum oxide (Al₂O₃) or niobium pentoxide (Nb₂O₅). Such a insulative bond can firmly combine every layer and provide insulation between two adjacent layers. When the insulative bond is liquid and daubed on the conductive layers, the insulative bond can easily fill the gaps of the conductive layers to increase evenness of the RI of the conductive layers.

Another available embodiment is to directly form the first transparent conductive layer on the transparent substrate and then form the transparent insulative layers and transparent conductive layers in the order as abovementioned. In other words, the first transparent insulative layer of the above embodiment may be selectively omitted.

### BRIEF DESCRIPTION OF THE DRAWINGS

FIG. 1 is an exploded view of the invention;

FIG. 2 is a top plan view of the invention;

FIG. 3 is a cross-sectional view of FIG. 2 along line III-III;

FIG. 4 is a cross-sectional view showing multiple insulative coatings; and

FIG. 5 is a cross-sectional view of another embodiment of the invention.

### DETAILED DESCRIPTION OF THE INVENTION

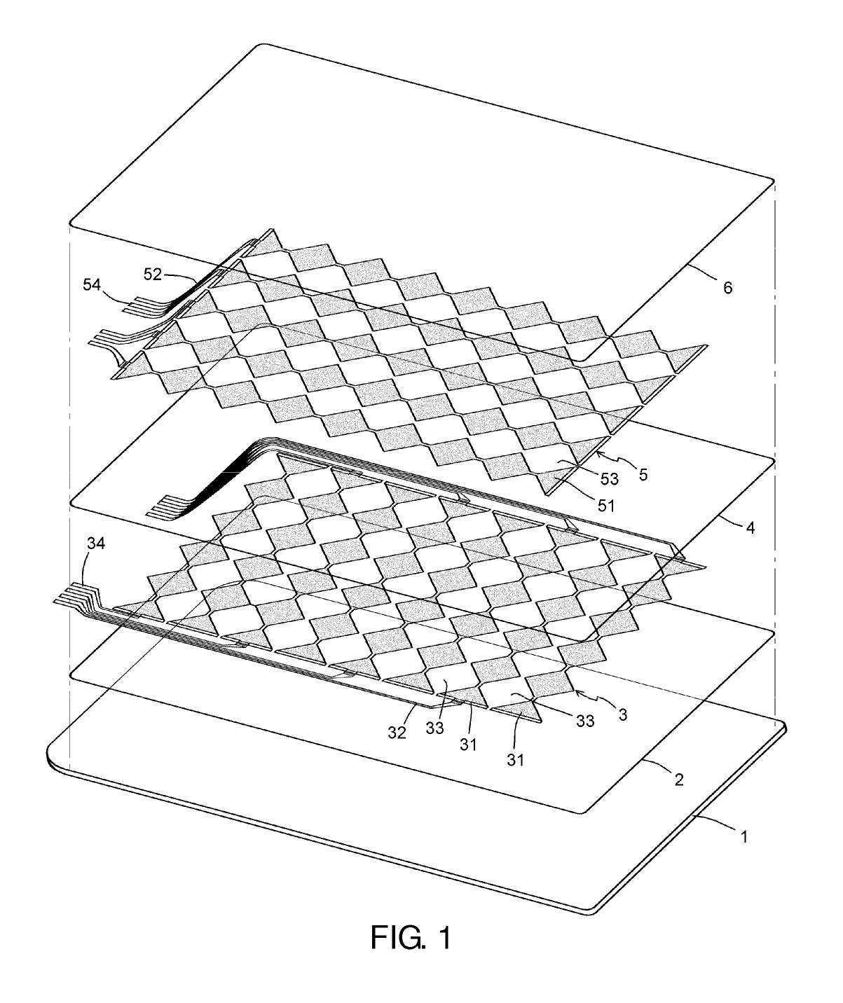

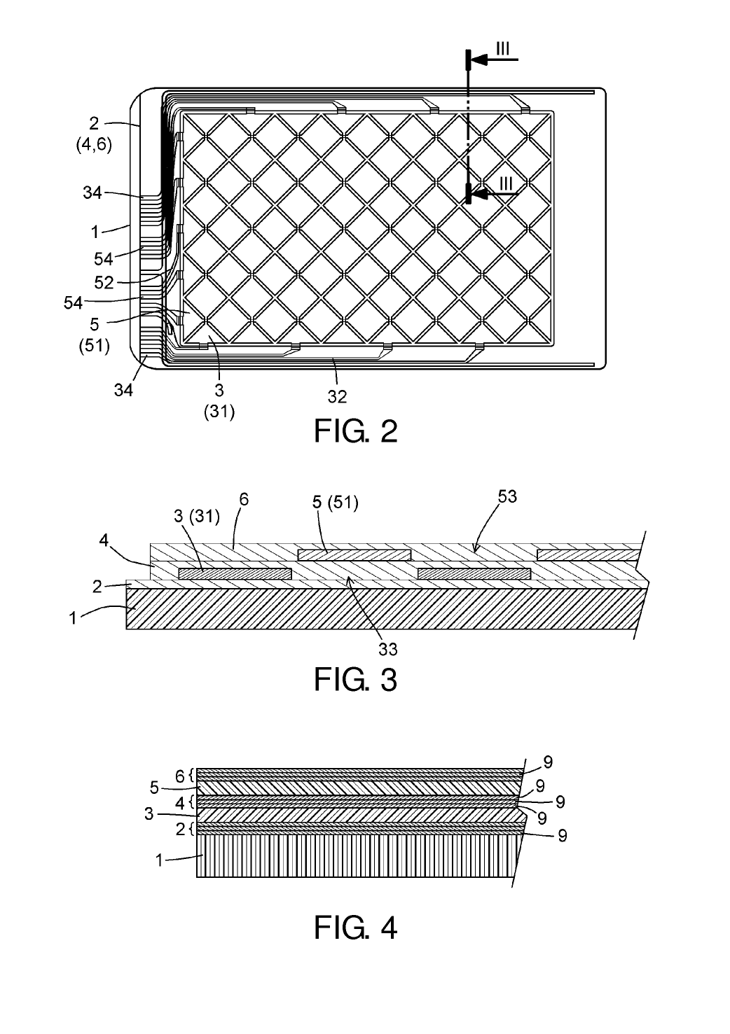

Please refer to FIGS. 1-3. The invention forms a fundamental insulative layer 2, an X-axis conductive layer 3, an intermediate insulative layer 4, a Y-axis transparent conductive layer 5, and a protective insulative layer 6 in sequence on a substrate 1.

The substrate 1 may use soda lime glass with a refractive index (RI) of about 1.5.

The X-axis and Y-axis conductive layers 3, 5 may use indium tin oxide (ITO). There are transparent X-axis capacitive sensor rows 31 at a constant interval along X-axis on the X-axis conductive layer 3. A gap 33 is remained between every two adjacent X-axis capacitive sensor rows 31. The gaps 33 divide the X-axis capacitive sensor rows 31 to be insulated. Ends of the X-axis capacitive sensor rows 31 are electrically separately connected with signal wires 32 with signal output ends 34. Similarly, there are transparent Y-axis capacitive sensor rows 51 at a constant interval along Y-axis on the Y-axis conductive layer 5. A gap 53 is remained between every two adjacent Y-axis capacitive sensor rows 51. The gaps 53 divide the Y-axis capacitive sensor rows 51 to be insulated. Ends of the Y-axis capacitive sensor rows 51 are electrically separately connected with signal wires 52 with signal output ends 54.

The insulative layers 2, 4, 6 use a material with a refraction index (RI) equal to or greater than that of the conductive layers 3, 5, such as a polymeric material containing silicon dioxide (SiO₂, RI≈1.6), aluminum oxide (Al₂O₃, RI≈1.8) or niobium pentoxide (Nb₂O₅, RI≈2.3). Generally speaking, a desired thickness of each of the insulative layers 2, 4, 6 is between 10 nm and 1000 nm. In a preferred embodiment, each of the insulative layers 2, 4, 6 is composed of multiple coatings, the dry coating method, such as the vacuum coating approach, is utilized to form multiple insulative coatings on the conductive layers 3, 5. Each single coating had better be below 100 nm to avoid internal stress due to excessive thickness. As shown in FIG. 4, each of the insulative layers 2, 4, 6 is composed of multiple coatings 9. Additionally, each of the insulative layers 2, 4, 6 may use two or more different coatings in material to obtain an insulative layer with a greater thickness, better insulation ability and a suitable RI for matching the conductive layer 3, 5. Preferably, the coatings 9 are odd in number, for example three or five, and the odd coatings are made of the same material to avoid deformation resulting from uneven stress.

The fundamental insulative layer 2 is completely superposed on the substrate 1. The intermediate insulative layer 4 is disposed on the X-axis conductive layer 3 and the gaps 33 are filled with an insulative material. The protective insulative layer 6 is disposed on the Y-axis conductive layer 5 and the gaps 53 are filled with an insulative material. By selecting the insulative material with an RI matching with the conductive layers 3, 5 and filling the gaps 33, 53 with the insulative material, evenness of RI and optical properties of the conductive layers 3, 5 can be effectively enhanced.

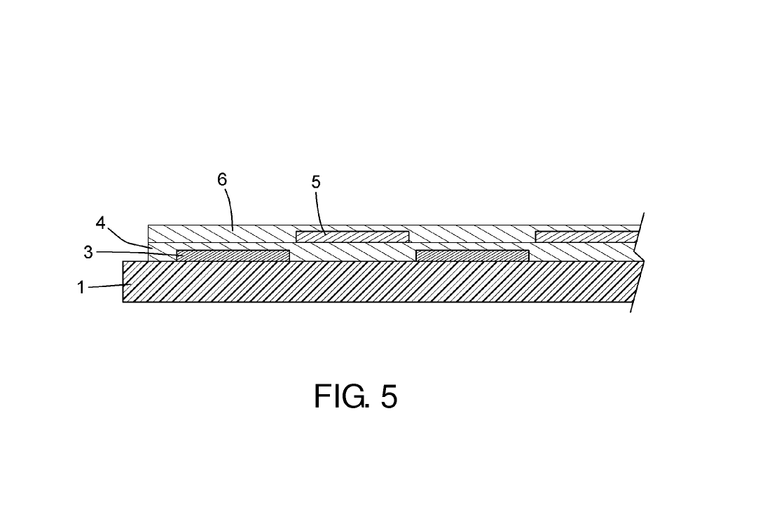

FIG. 5 shows another embodiment of the invention. This embodiment is to directly form the X-axis conductive layer 3 on the substrate 1 and then form the intermediate insulative layer 4, Y-axis conductive layer 5 and protective insulative layer 6 in the order as abovementioned. In other words, the first transparent insulative layer of the above embodiment may be selectively omitted to simplify the manufacturing process and reduce the costs.

The foregoing description is only the most preferred embodiments of the present invention, but the structural feature of the present invention is not limited thereto. It would be appreciated by those skilled in the art that variations or modifications may be contemplated readily without departing from the following claims of the invention.

What is claimed is:

1. A transparent capacitive touch panel comprising:
a transparent substrate;
a first transparent conductive layer, formed on the transparent substrate, and having a plurality of first capacitive sensor rows along a first axis, wherein every adjacent two of the first capacitive sensor rows are formed with a first gap to be insulated;
a first transparent insulative layer, formed on the first transparent conductive layer, having a refractive index approximately equal to that of the first transparent conductive layer, and filling the first gaps;
a second transparent conductive layer, formed on the first transparent insulative layer, having a plurality of second capacitive sensor rows along a second axis, wherein every adjacent two of the second capacitive sensor rows are formed with a second gap to be insulated; and
a second transparent insulative layer, formed on the second transparent conductive layer, having a refractive index approximately equal to that of the second transparent conductive layer, and filling the second gaps.

2. The transparent capacitive touch panel of claim 1, wherein the transparent substrate is made of soda lime glass, soda borosilicate glass, lead crystal glass, aluminosilicate glass or low-iron glass.

3. The transparent capacitive touch panel of claim 1, wherein the transparent substrate is made of polycarbonates (PC), polyethylene terephthalate (PET) or polymethylmethacrylate (PMMA).

4. The transparent capacitive touch panel of claim 1, wherein the first and second transparent conductive layers indium tin oxide (ITO), indium zinc oxide (IZO), aluminum zinc oxide (AZO) or poly(3,4-ethylenedioxythiophene) (PEDOT).

5. The transparent capacitive touch panel of claim 1, wherein each of the first and second transparent insulative layers is composed of multiple coatings, and each coating is less than 100 nm in thickness.

6. The transparent capacitive touch panel of claim 5, wherein the coatings are made of silicon dioxide (SiO₂), aluminum oxide (Al₂O₃) or niobium pentoxide (Nb₂O₅).

7. The transparent capacitive touch panel of claim 5, wherein each set of the coatings is three or an odd number more than three in number, and the odd coatings are made of the same material.

8. The transparent capacitive touch panel of claim 1, wherein each of the first and second transparent insulative layers is a transparent insulative bond.

9. The transparent capacitive touch panel of claim 1, further comprising a third transparent insulative layer between the transparent substrate and the first transparent conductive layer.

10. The transparent capacitive touch panel of claim 9, wherein the third transparent insulative layers is composed of multiple coatings, and each coating is less than 100 nm in thickness.

11. The transparent capacitive touch panel of claim 10, wherein the coatings are made of silicon dioxide (SiO₂), aluminum oxide (Al₂O₃) or niobium pentoxide (Nb₂O₅).

12. The transparent capacitive touch panel of claim 1, wherein each of the first and second transparent insulative layers is a bond containing silicon dioxide (SiO₂), aluminum oxide (Al₂O₃) or niobium pentoxide (Nb₂O₅).

13. A transparent capacitive touch panel comprising:
a transparent substrate;
a first transparent conductive layer, formed on the transparent substrate, and having a plurality of first capacitive sensor rows along a first axis, wherein every two adjacent two of the first capacitive sensor rows are formed with a first gap to be insulated;
a first transparent insulative layer, formed on the first transparent conductive layer, having an refractive index greater than that of the first transparent conductive layer, and filling the first gaps;
a second transparent conductive layer, formed on the first transparent insulative layer, having a plurality of second capacitive sensor rows along a second axis, wherein every two adjacent two of the second capacitive sensor rows are formed with a second gap to be insulated; and
a second transparent insulative layer, formed on the second transparent conductive layer, having an refractive index greater than that of the second transparent conductive layer, and filling the second gaps.
